(19) United States
(12) Patent Application Publication
(10) Pub. No.: US 2013/0055993 A1
(43) Pub. Date: Mar. 7, 2013

(54) CYLINDER LINER WITH A THERMAL BARRIER COATING

(71) Applicants: Troy Clayton Kantola, Whitmore Lake, MI (US); Blair Matthew Jenness, Grosse Pointe Park, MI (US); Robert Reuven Aharonov, W. Bloomfield, MI (US)

(72) Inventors: Troy Clayton Kantola, Whitmore Lake, MI (US); Blair Matthew Jenness, Grosse Pointe Park, MI (US); Robert Reuven Aharonov, W. Bloomfield, MI (US)

(21) Appl. No.: 13/606,286

(22) Filed: Sep. 7, 2012

Related U.S. Application Data
(60) Provisional application No. 61/531,804, filed on Sep. 7, 2011.

(51) Int. Cl. F02B 75/08; B05D 1/08

(52) U.S. Cl. 123/668; 427/446

(57) ABSTRACT

A cylinder liner includes a body formed of a metal material extending circumferentially around a center axis with an outer surface facing away from the center axis. A thermal barrier coating including an insulating material having a thermal conductivity of not greater than 5 W/(m·K) is applied to the outer surface. The thermal barrier coating is thermally applied to the outer surface at a velocity of 100 to 1,000 m/s, for example by a high velocity oxygen fuel (HVOF) spray, a plasma spray, or a detonation gun.

### CROSS REFERENCE TO RELATED APPLICATION

This application claims the benefit of U.S. provisional application Ser. No. 61/531,804, filed Sep. 7, 2011, the contents of which are incorporated herein by reference in its entirety.

### BACKGROUND OF THE INVENTION

1. Field of the Invention

This invention relates generally to cylinder liners, and more particularly to coated cylinder liners, and methods of forming the same.

2. Description of the Prior Art

Cylinders of internal combustion engines often include a sleeve or liner providing an outer surface and inner surface surrounding a cylindrical area. The cylinder liner includes a body that can be fitted to the engine block to form the cylinder. The inner surface of the cylinder liner faces toward a piston and provides an interface or sliding surface for the piston rings during a combustion cycle and operation of the internal combustion engine. Thus, the body of the cylinder liner is typically fowled of a hard, wear resistant material. The cylinder liner is also preferably formed of a material capable of handling the extreme conditions encountered during the combustion cycle, including high temperatures and pressures. An insulating coating can be disposed on the outer surface of the cylinder liner to improve thermal efficiency of the internal combustion engine. An example of a cylinder liner with an insulating coating designed to improve the thermal efficiency is disclosed in U.S. Pat. No. 4,921,734 to Thorpe et al.

### SUMMARY OF THE INVENTION

One aspect of the invention provides a cylinder liner including a body formed of a metal material extending circumferentially around a center axis and longitudinally between opposite ends. The body includes an outer surface facing away from the center axis. A thermal barrier coating including an insulating material having a thermal conductivity of not greater than 4 W/(m·K) is applied to the outer surface. The thermal barrier coating is applied to the outer surface by a process comprising the steps of: heating a plurality of powder particles of the insulating material having a nominal particle size of −140+10 μm to melt the insulating material, and conveying the melted insulating material to the outer surface of the cylinder liner at a velocity of 100 to 1,000 m/s.

Another aspect of the invention provides a method of manufacturing a cylinder liner. The method includes providing a body extending circumferentially a center axis with an outer surface facing away from the center axis; heating a plurality of powder particles of an insulating material having a nominal particle size of −140+10 μm to melt the powder particles of insulating material; and conveying the melted insulating material to the outer surface of the cylinder liner at a velocity of 100 to 1,000 m/s to provide a thermal barrier coating on the outer surface.

The insulated cylinder liner of the present invention provides better insulation and is manufactured according to a more efficient method than insulated cylinder liners of the prior art.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a cylinder liner according to one embodiment of the invention;

FIG. 2 is a cross-sectional view of a portion of the cylinder liner of FIG. 1;

FIG. 3 illustrates applying an insulating material to the outer surface of the cylinder liner by a high velocity oxygen fuel (HVOF) spray;

FIG. 4 illustrates applying the insulating material to the outer surface of the cylinder liner by a plasma spray; and

FIG. 5 illustrates applying the insulating material to the outer surface of the cylinder liner by a detonation gun.

### DETAILED DESCRIPTION OF THE ENABLING EMBODIMENTS

One aspect of the invention provides a cylinder liner 20 for being disposed in a cylinder block and receiving a piston of an internal combustion engine. A thermal barrier coating 22 formed of at least one insulating material is applied to the cylinder liner 20 at a velocity of at least 100 m/s, for example by a high velocity oxygen fuel (HVOF) spray, a plasma spray, or a detonation gun. A bond layer 34 is preferably applied to the cylinder liner 20 to promote adhesion of the thermal barrier coating 22. The insulated cylinder liner 20 of the present invention provides improved insulation compared to those of the prior art.

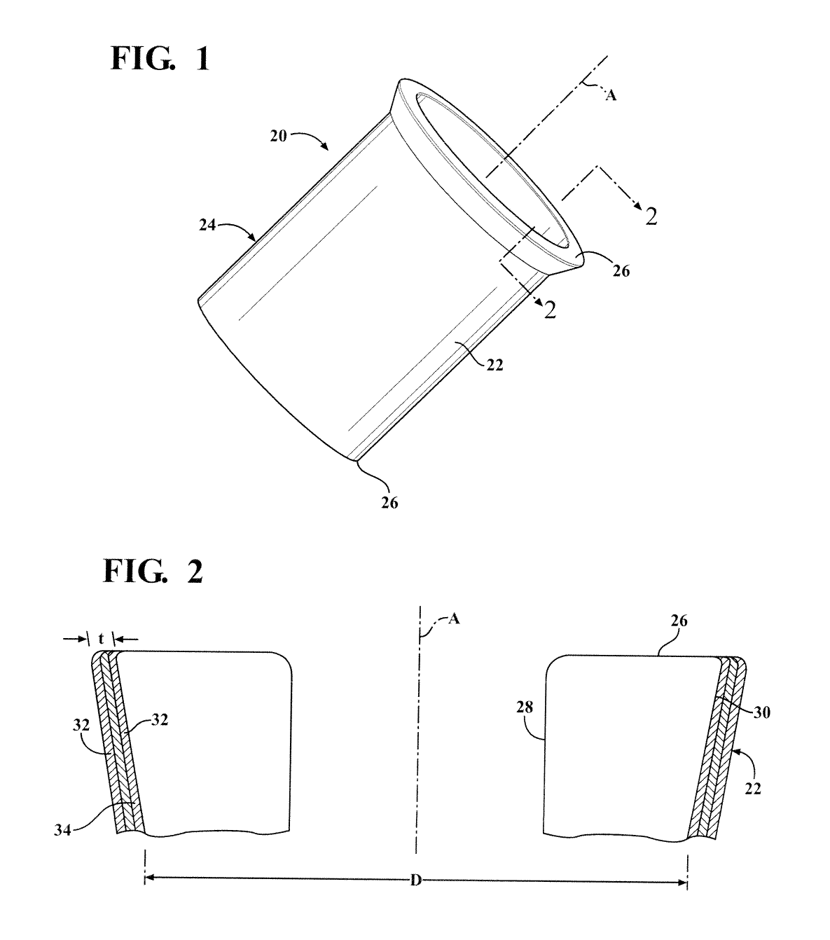

As shown in FIGS. 1 and 2, the cylinder liner 20 includes a body 24 formed of a metal material extending circumferentially a center axis A and longitudinally between opposite ends 26. The body 24 includes an inner surface 28 facing the center axis A and an outer surface 30 facing opposite the inner surface 28 and away from the center axis A. The inner surface 28 presents an opening having a cylindrical shape. The volume of the opening allows the cylinder liner 20 to receive the piston, such that the piston can reciprocate within the cylinder liner 20 and slide along the inner surface 28 during operating of the internal combustion engine.

The outer surface 30 of the cylinder liner 20 presents a diameter D extending across the opening and through the center axis A. In one embodiment, the diameter D is from 50 cm to 200 cm. The outer surface 30 also presents a surface area extending continuously between the opposite ends 26.

The metal material forming the body 24 preferably has a hardness of at least 20 HRC and a thermal conductivity of 40 to 50 W/(m·K). This material is capable of withstanding the extreme conductions during a typical combustion cycle. According to one embodiment, the metal material includes a steel alloy.

The thermal barrier coating 22 is formed of the insulating material is applied to the outer surface 30 of the body 24 and preferably covers the entire outer surface 30, extending continuously over the surface area around the center axis A and between the opposite ends 26. The thermal barrier coating 22 has an overall thermal conductivity of 0.4 to 4 W/(m·K), and preferably not greater than 2 W/(m·K). The thermal barrier coating 22 also has a porosity of 5 to 30%. The thermal barrier coating 22 includes at least one layer of insulating material 32, but may include a plurality of layers 32. As shown in FIG. 2, the thermal barrier coating 22 has a thickness t extending perpendicular to the outer surface 30, which is preferably from 100 to 5,000 microns.

The insulating materials of the thermal barrier coating 22 each have a thermal conductivity of not greater than 5 W/(m·K). The thermal barrier coating 22 may be formed entirely of the insulating materials, or may include other materials in addition to the at least one insulating material. In one embodiment, the insulating materials include a ceramic or a metal, for example alumina, a nickel-based alloy, or stainless steel.

In one preferred embodiment, one or more layer 32 of the thermal barrier coating 22 includes, in weight percent (wt. %) of the thermal barrier coating 22, at least 70.0 wt. % ZrO₂; or at least 80.0 wt. % ZrO₂; or at least 90.0 wt. % ZrO₂; or at least 95.0 wt. % ZrO₂. Typically, the thermal barrier coating 22 includes a plurality of layers 32 each having a different composition. In one preferred embodiment, one or more layers 32 of the thermal barrier coating 22 includes, in wt. % of the thermal barrier coating 22, 7.0 to 9.0 wt. % Y₂O₃; up to 0.7 wt. % SiO₂; up to 0.2 wt. % TiO₂; up to 0.2 wt. % Al₂O₃; up to 0.2 wt. % Fe₂O₃; and a balance of ZrO₂. Other example compositions that can be used to form one or more of the layers 32 include: 8.0 wt. % Y₂O₃ and a balance of ZrO₂; 20.0 wt. % Y₂O₃ and a balance of ZrO₂, 24.0 wt. % CeO₂ and a balance of ZrO₂; ZrO₂-256O₂-2Y₂O₃; CaTiO₃; and Al₂O₃.

The thermal barrier coating 22 is thermally applied to the outer surface 30 of the cylinder liner 20 at the velocity of at least 100 m/s, such as by the high velocity oxygen fuel (HVOF) spray, the plasma spray, or the detonation gun. The process of applying the thermal barrier coating 22 to the outer surface 30 first includes providing a plurality of powder particles of the insulating material. Each of the powder particles have a nominal particle size of −140+10 μm, meaning that all of the power particles will pass through a sieve with 140 μm openings, but none of the powder particles will pass through a sieve with 10 μm openings. Next, the method includes heating the powder particles of insulating material to a temperature of 2,500 to 3,000° C. to melt the insulating material, and then conveying the melted powder particles of insulating material to the outer surface 30 of the cylinder liner 20 at a velocity of 100 to 1,000 m/s, or greater than 1,000 m/s.

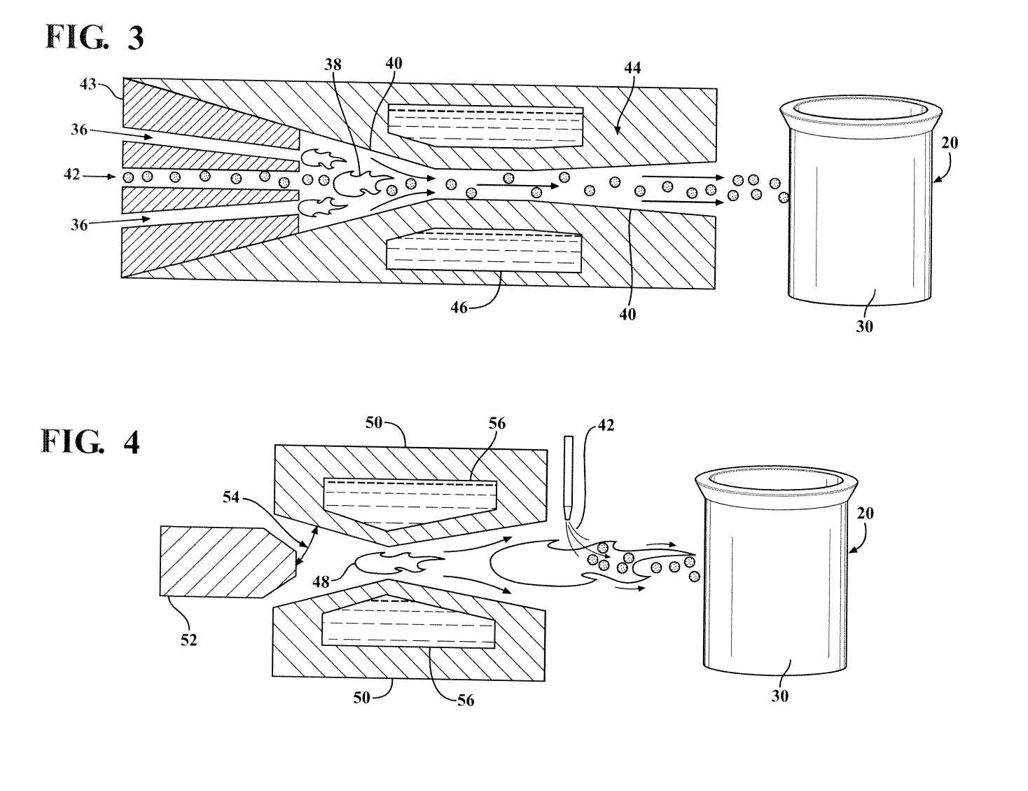

In one preferred embodiment, the thermal barrier coating 22 is applied to the cylinder liner 20 by the HVOF spray pointed at the outer surface 30, as shown in FIG. 3. This process includes continuously providing or pumping a mixture 36 of fuel and oxygen in the form of gas or liquid into a chamber 38. The mixture is continuously heated and ignited in the chamber. The ignited mixture is then transferred into a spray nozzle 40 and travels as a stream through the nozzle 40 at a pressure of 240 to 900 KPa and a high velocity. The power particles 42 of insulating material and a carrier gas are injected into the stream in the nozzle and melt upon contacting the stream of ignited oxygen. The melted, pressurized, and heated powder particles 42 are conveyed in the high velocity stream to the outer surface 30 of the cylinder liner 20 by spraying through an exit of the nozzle 40. The nozzle 40 is surrounded by a barrel 44 with an air gap and cooling water 46 between the barrel 44 and the nozzle 40. The melted powder particles 42 travel at a velocity of 600 to 800 m/s, and preferably greater than 1000 m/s, from the nozzle to the outer surface 30 of the cylinder liner 20 to form the thermal barrier coating 22.

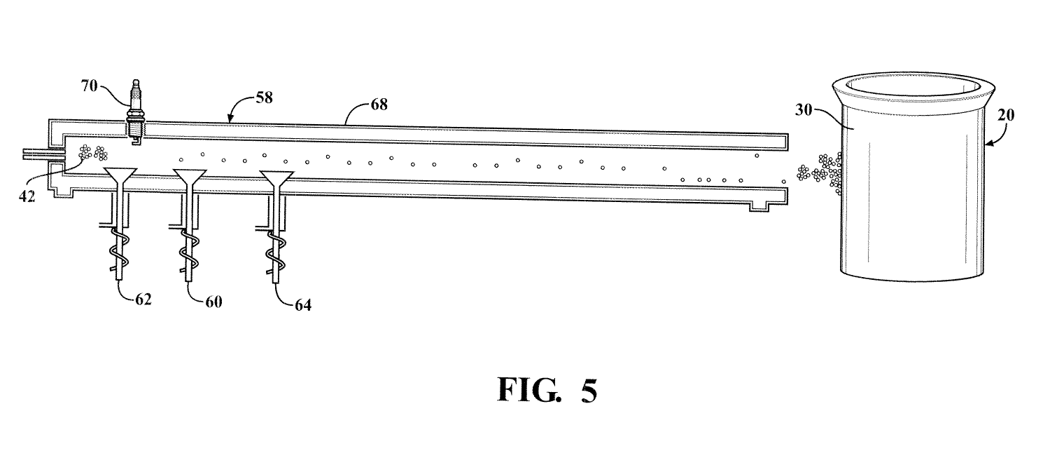

In another preferred embodiment, the thermal barrier coating 22 is applied to the cylinder liner 20 by the plasma spray pointed at the outer surface 30, as shown in FIG. 4. This process first includes providing a plasma stream 48 from a plasma torch 43, wherein the plasma stream 48 is formed of gas having a temperature of from 10,000 to 15,000 K. The plasma stream 48 is provided by a pair of nozzles (anode) 50, and an electrode (cathode) 52. A high intensity electric arc 54 forms between one of the nozzles 50 and the electrode 52. The plasma gas forming the plasma stream 48 comprises one or more of argon, hydrogen, nitrogen, and helium. The nozzle 50 and electrode 52 both contain cooling water 56. The powder particles 42 of insulating material are melted by injecting the powder particles 42 along with a carrier gas into the plasma stream 48. The melted powder particles 42 transform into droplets of the insulating material upon contacting the plasma stream 48. The plasma spray then conveys the droplets to the outer surface 30 of the cylinder liner 20 at a velocity of 100 to 300 m/s.

In yet another embodiment, the thermal barrier coating 22 is applied to the cylinder liner 20 by a detonation gun 58 pointed at the outer surface 30, as shown in FIG. 5. This process includes feeding a mixture of fuel 60, nitrogen 62, and oxygen 64 into a barrel 68 of the detonation gun 58. The powder particles 42 of insulating material are melted and are fed into the barrel 68 along with the mixture of fuel and oxygen. The mixture is then ignited by a spark plug 70 to force the melted particles 42 of insulating material out of the barrel 68 and onto the outer surface 30 at a velocity of 600 to 900 m/s.

According to one preferred embodiment, as shown in FIG. 2, a bond layer 34 is disposed between the outer surface 30 of the body 24 and the thermal barrier coating 22 to improve adhesion between the thermal barrier coating 22 and the outer surface 30. The bond layer 34 can also be thermally applied to the outer surface 30 of the cylinder liner 20 at a velocity of at least 100 m/s, such as by the high velocity oxygen fuel (HVOF) spray, the plasma spray, or the detonation gun.

The bond layer 34 typically includes chromium, aluminum, and yttrium. In one preferred embodiment, the bond layer 34 consists of MCrAlY, wherein M is Co, Ni, Fe or a mixture of Co and Ni. Example compositions of the bond layer 34 include NiCrAlY, CoCrAlY, NiCrAlY, and CoNiCrAlY.

The thermal barrier coating 22 insulates the cylinder liner 20 by keeping energy, specifically heat, within the center opening of the cylinder liner 20. The thermal barrier coating 22 prevents heat rejection from escaping out of the cylindrical opening of cylinder liner 20, which is typically enhanced by cooling systems around the cylinder liner 20. The heat maintained within the cylindrical opening, inside the cylinder liner 20, is an additional source of energy that can be used to improve engine operating efficiency. In one embodiment, the insulated cylinder liner 20 minimizes heat flow from within the cylindrical opening to a surrounding water jacket of the internal combustion engine. The insulated cylinder liner 20 of the present invention can improve the thermal efficiency of the internal combustion engine.

Obviously, many modifications and variations of the present invention are possible in light of the above teachings and may be practiced otherwise than as specifically described while within the scope of the appended claims.

What is claimed is:

1. A cylinder liner, comprising:
a body formed of a metal material extending circumferentially around a center axis and longitudinally between opposite ends,
said body including an outer surface facing away from said center axis,
a thermal barrier coating including an insulating material applied to said outer surface of said body,
said insulating material having a thermal conductivity of not greater than 5 W/(m·K),
said thermal barrier coating applied to said outer surface by a process comprising the steps of:
heating a plurality of powder particles of said insulating material having a nominal particle size of −140+10 μm to melt said insulating material, and conveying said melted insulating material to said outer surface of said cylinder liner at a velocity of 100 to 1,000 m/s.

2. The cylinder liner of claim 1 wherein said thermal barrier coating includes a plurality of layers, and wherein at least one of said layers includes at least 70.0 wt. % ZrO₂.

3. The cylinder liner of claim 2 wherein at least one of said layers includes, in weight percent of said layer, 8.0 wt. % Y₂O₃ and a balance of ZrO₂

4. The cylinder liner of claim 1 wherein the conveying step includes spraying said insulating material onto said outer surface of said cylinder liner.

5. The cylinder liner of claim 1 wherein the heating step includes heating said powder particles to a temperature of 2,500 to 3,000° C.

6. The cylinder liner of claim 1 wherein said outer surface presents a surface area extending continuously around said center axis and between said opposite ends, and said thermal barrier coating covers said surface area.

7. The cylinder liner of claim 1, wherein the process of applying said thermal barrier coating to said outer surface includes a high velocity oxy-thermal thermal (HVOF) spray.

8. The cylinder liner of claim 7 wherein the process further comprises the steps of:
continuously combusting a mixture of fuel and oxygen in a chamber,
transferring a stream of said ignited mixture through a nozzle,
injecting the melted powder particles into said stream, and
the conveying step including spraying said stream including said melted powder particles through an exit of said nozzle to said outer surface of said cylinder liner at a velocity of 600 to 1,000 m/s.

9. The cylinder liner of claim 1, wherein the process of applying said thermal barrier coating to said outer surface includes a plasma spray.

10. The cylinder liner of claim 9, wherein the process further comprises the steps of:
ejecting a plasma stream from a plasma torch,
said plasma stream being formed of gas having a temperature of 10,000 to 15,000 K,
injecting said melted powder particles into said plasma stream to form a plurality of droplets of said insulating material, and
the conveying step including spraying said plasma stream including said melted droplets of insulating material onto said outer surface of said cylinder liner at a velocity of 100 to 300 m/s.

11. The cylinder liner of claim 1, wherein the process of applying said thermal barrier coating to said outer surface includes a detonation gun.

12. The cylinder liner of claim 11, wherein the process further comprises the steps of:
feeding a mixture of fuel and oxygen and into a barrel of a detonation gun,
feeding said melted powder particles of insulating material into said barrel along with said mixture of fuel and oxygen, and
said conveying step including igniting said mixture of fuel and oxygen to force said melted insulating material through an exit of said barrel onto said outer surface of said cylinder at a velocity of 550 to 900 m/s.

13. A method of manufacturing a cylinder liner, comprising the steps of
providing a body extending circumferentially a center axis with an outer surface facing away from the center axis,
heating a plurality of powder particles of an insulating material having a nominal particle size of −140+10 μm to melt the insulating material, and
conveying the melted insulating material to the outer surface of the cylinder liner at a velocity of 100 to 1,000 m/s to provide a thermal barrier coating on the outer surface.

14. The method of claim 13 wherein the conveying step includes covering the outer surface with the insulating material.

15. The method of claim 13 further comprising the steps of:
continuously combusting a mixture of fuel and oxygen in a chamber,
transferring a stream of the ignited mixture through a nozzle,
the heating step including injecting the melted powder particles into the stream, and
the conveying step including spraying the stream and melted insulating material through an exit of the nozzle to the outer surface of the cylinder liner at a velocity of 600 to 1,000 m/s.

16. The method of claim 13 further comprising the steps of:
providing a plasma stream formed of gas and liquid having a temperature of from 10,000 to 15,000 K from a plasma torch,
the heating step including injecting the powder particles of insulating material into the plasma stream to melt the insulating material and form droplets of the insulating material, and
the conveying step including spraying the plasma stream including the droplets of insulating material onto the outer surface of the cylinder liner at a velocity of 100 to 300 m/s.

17. The method of claim 13 further comprising the steps of:
feeding a mixture of fuel and oxygen into a barrel of a detonation gun,
the heating step including feeding the powder particles of insulating material into the barrel along with the mixture of fuel and oxygen, and
the conveying step including igniting the mixture of fuel and oxygen to force the melted insulating material through an exit of the barrel onto the outer surface at a velocity of 500 to 900 m/s.
